(19) United States
(12) Patent Application Publication
(10) Pub. No.: US 2016/0073459 A1
(43) Pub. Date: Mar. 10, 2016

(54) LED LAMP DEVICE

(71) Applicant: OSRAM GmbH, Munich (DE)

(72) Inventors: Xusheng Yang, Shenzhen (CN); Moritz Engl, Regensburg (DE); Shaoping Chen, Shenzhen (CN); Shijun Nie, Shenzhen (CN)

(21) Appl. No.: 14/849,705

(22) Filed: Sep. 10, 2015

(30) Foreign Application Priority Data
Sep. 10, 2014 (CN) 201410457926.3

(51) Int. Cl. H05B 33/08

(52) U.S. Cl. CPC H05B 33/0815; H05B 33/0887; H05B 33/089

(57) ABSTRACT

Various embodiments relate to an LED lamp device. According to various embodiments, an LED lamp device is provided, including an LED unit for emitting light, a driving unit for driving the LED unit, such that the LED unit emits light at an operating point, and a resonance unit for receiving an input, providing AC power to the driving unit, and protecting the driving unit and the LED unit from being damaged by the input.

### CROSS-REFERENCE TO RELATED APPLICATION

This application claims priority to Chinese Patent Application Serial No. 201410457926.3, which was filed Sep. 10, 2014, and is incorporated herein by reference in its entirety.

### TECHNICAL FIELD

Various embodiments generally relate to the field of illumination, and particularly to an LED lamp device.

### BACKGROUND

In daily life, fluorescent lamps are conventional light sources, which have been used widely. Most of illumination devices use the fluorescent lamps as light sources.

In recent years, however, LED (light-emitting diode) light emission technology has developed fast. Since LED lamps have relatively high efficiency and relatively long lifetime, a tendency of gradually replacing the fluorescent lamps with the LED lamps arises. To emit light having the same brightness, an LED lamp consumes less energy than a fluorescent lamp. That is, the LED lamps have higher light emission efficiency than the fluorescent lamps. Moreover, with the development of the LED light emission technology, the lifetime of the LED lamps has reached a satisfactory degree, and even can exceed that of general fluorescent lamps. In addition, the cost of manufacturing the LED lamps is decreasing gradually. Therefore, more and more fluorescent lamps will be replaced with the LED lamps in the future, so as to save energy sources.

Due to the inherent electrical and optical characteristics of the fluorescent lamps, in most of the existing circuits using a fluorescent lamp to emit light, an electronic ballast (ECG) is used as a component connected between an AC power supply and a fluorescent lamp. For example, in the case of using a self-resonance electronic ballast, the self-resonance electronic ballast may generate an instant high voltage (e.g., 1000V or higher) during startup, such that the fluorescent lamp can be broken-down ionizedly in order to emit light. After the ionization breakdown of the fluorescent lamp, the operating voltage of the fluorescent lamp reduces to and maintains at a proper voltage value, so as to emit light continuously.

For the LED lamps, however, since the light emission principle of the LED lamps differs from that of the fluorescent lamps, the instant high voltage is not needed for startup of the LED lamps. Disadvantageously, an instant high voltage (e.g., 1000V or higher) may damage the LED lamps. Currently, drivers for AC/DC conversion and output power adjustment have been integrated into some LED lamp devices, and such an instant high voltage may also damage the drivers.

To enable an LED lamp device not only to operate normally but also to be free of damages resulting from an instant high voltage in an existing illumination circuit, during replacing an existing fluorescent lamp in the illumination circuit with the LED lamp device, the existing circuit has to be further modified, for example, to uninstall the electronic ballast or to bypass the electronic ballast, so as to disable the electronic ballast. However, these approaches are inconvenient, and increase time and labor cost for upgrading the illumination circuit.

### SUMMARY

Various embodiments provide an LED lamp device which can replace an existing fluorescent lamp in a conventional illumination circuit, conveniently.

According to various embodiments, an LED lamp device is provided, including: an LED unit for emitting light; a driving unit for driving the LED unit, such that the LED unit emits light at an operating point; and a resonance unit for receiving an input and providing AC power to the driving unit, and protecting the driving unit and the LED unit from being damaged by the input.

According to various embodiments, the presence of the resonance unit can protect the driving unit and the LED unit from being damaged by an input from outside the LED lamp device, while ensuring the LED unit to emit light normally.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 illustrates a schematic view of an LED lamp device according to an embodiment of the present disclosure;

FIG. 2 illustrates a schematic view of the LED lamp device as shown in FIG. 1 connected with an electronic ballast in an existing fluorescent lamp light-emitting circuit;

FIG. 3 illustrates a comparison between input power of the LED lamp device having a resonance unit and that of the LED lamp device having no resonance unit by using the same self-resonance electronic ballast;

FIG. 4 illustrates a schematic view of an LED lamp device according to another embodiment of the present disclosure connected with an electronic ballast in an existing fluorescent lamp light-emitting circuit;

FIG. 5 schematically illustrates the relationship between the current and the frequency in the circuit formed by connecting in series the inductor and the capacitor in the resonance unit according to an embodiment of the present disclosure;

FIG. 6 illustrates a schematic view of an LED lamp device according to another example of the present disclosure connected to an AC voltage source; and

FIG. 7 illustrates a schematic view of an LED lamp device according to another embodiment of the present disclosure.

### DETAILED DESCRIPTION

Hereinafter, embodiments of the invention will be described in detail with reference to the appended drawings. It should be noted that the following descriptions are exemplary only but do not intend to limit the invention. In addition, in the following descriptions, identical or similar components in different figures will be denoted by identical reference numerals.

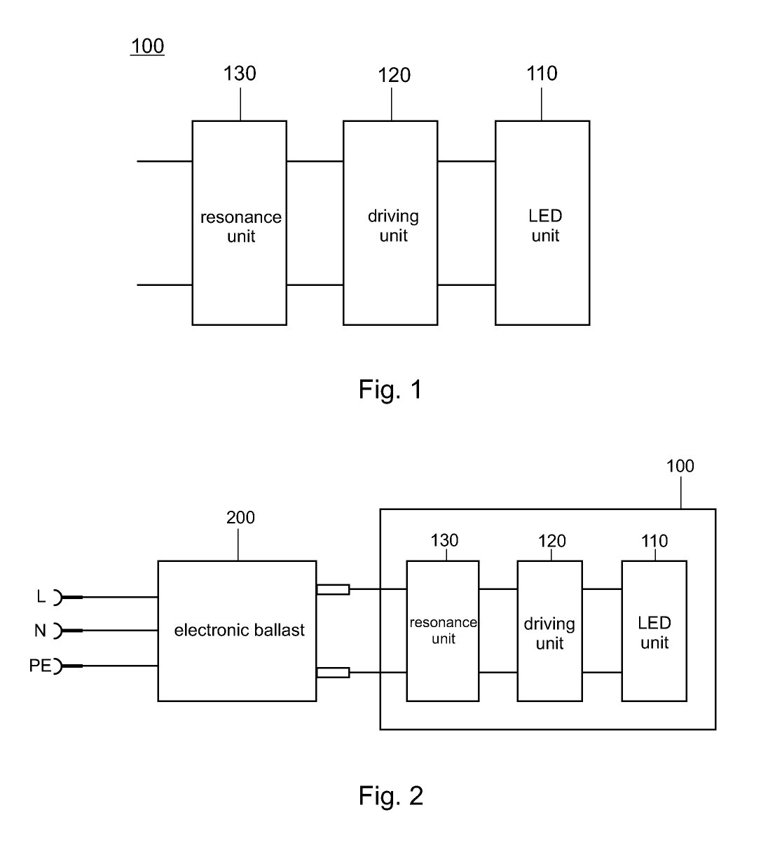

FIG. 1 illustrates a schematic view of an LED lamp device according to an embodiment of the present disclosure. As shown in FIG. 1, an LED lamp device 100 may include an LED unit 110, a driving unit 120 and a resonance unit 130. The LED unit 100 may include one or more LEDs as light-emitting elements, so as to emit light during power up. The driving unit 120 is connected with the LED unit 110, and is used for driving the LED unit 110, such that the LED unit emits light at a proper operating point. The driving unit 120 can convert an AC received from the resonance unit 130 to a DC and thereby provide the DC to the LED unit 110 for emitting light. According to an example of the present disclosure, different LED units may have different proper operating points (i.e. proper rated power), and the driving unit 120 can adjust the DC power provided to the LED unit 110 according to the operating state of the LED unit 110, such that the LED unit 110 operates at a proper operating point. The resonance unit 130 can receive an input from outside of the LED lamp device 100, and provide AC power to the driving unit 120 upon the receipt of the input. According to the present disclosure, the presence of the resonance unit 130 can protect the driving unit 120 and the LED unit 110 from being damaged by the input from outside of the LED lamp device 100, while ensuring the LED unit 110 to emit light properly.

FIG. 2 illustrates a schematic view of the LED lamp device as shown in FIG. 1 connected with an electronic ballast in an existing fluorescent lamp light-emitting circuit. In replacing the conventional fluorescent lamp in the illumination circuit with the LED lamp device according to the present disclosure so as to upgrade the illumination circuit, the conventional fluorescent lamp can be replaced directly with the LED lamp device according to the present disclosure. As shown in FIG. 2, the existing illumination circuit already includes an electronic ballast 200 which is powered by an AC power supply. In FIG. 2, L represents a live line, N represents a neutral line, and PE represents a protective earth line. According to an embodiment of the present disclosure, the resonance unit 130 of the LED lamp device 100 is connected to the electronic ballast 200, so as to receive an output of the electronic ballast 200. The output of the electronic ballast 200 is provided to the driving unit 120 via the resonance unit 130, whereby the resonance unit 130 protects the respective components in the driving unit 120 and the LED unit 110 from being damaged by the output of the electronic ballast 200.

Particularly, according to an embodiment of the present disclosure, the LED lamp device 100 is used for replacing the fluorescent lamp in the existing illumination circuit. One function of the electronic ballast 200 in the existing fluorescent lamp light-emitting circuit is to generate an instant high voltage (e.g., 1000V or higher) during startup, such that the fluorescent lamp is broken-down ionizedly in order to emit light. In contrast, the LED unit 110 according to the present disclosure emits light without needing such a high startup voltage, and a relatively high instant voltage may damage the driving unit 120 and/or the LED unit 110. Therefore, the presence of the resonance unit 130 can protect respective components in the driving unit 120 and the LED unit 110 from being damaged by the instant high voltage generated by the electronic ballast 200, such that the LED lamp device 100 is adapted to use the output of the existing electronic ballast 200 to emit light.

Accordingly, in replacing the conventional fluorescent lamp in the illumination circuit with the LED lamp device, the conventional fluorescent lamp may be replaced directly with the LED lamp device according to the present disclosure, without needing any further modification to the existing circuit, i.e. without uninstallation of the existing electronic ballast and without bypass for the existing electronic ballast for disabling the electronic ballast, thereby simplifying operations and reducing the time and labor cost for upgrading the illumination circuit.

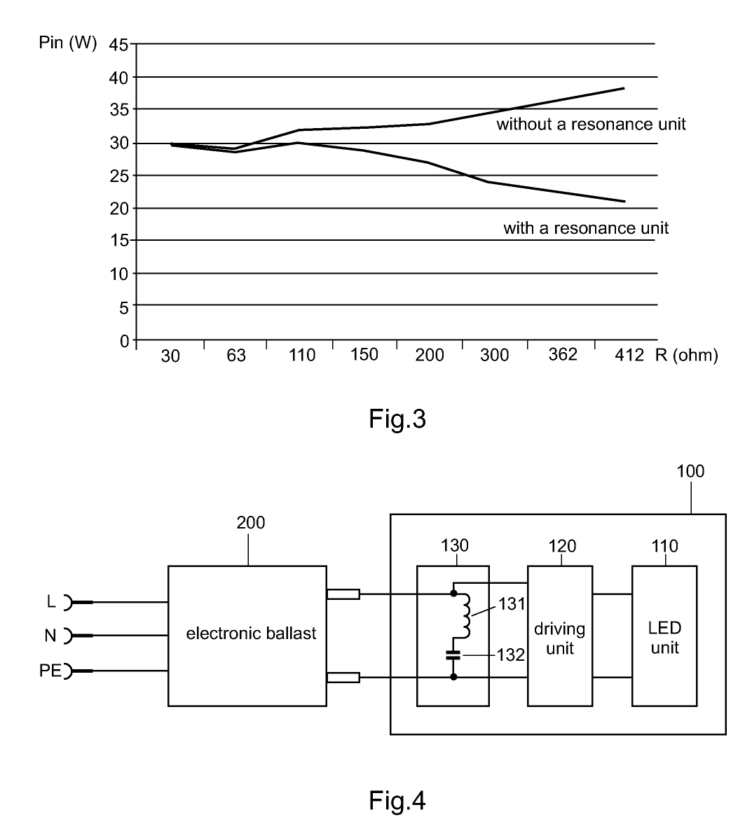

FIG. 3 illustrates a comparison between input power of the LED lamp device having a resonance unit and that of the LED lamp device having no resonance unit, by using the same self-resonance electronic ballast. In FIG. 3, the X-coordinate represents the impedance of an equivalent circuit of the LED unit 110, and the Y-coordinate represents the AC power input to the LED lamp device (i.e. the power output from the electronic ballast). As can be seen from FIG. 3, with the addition of a resonance unit to the LED lamp device, the AC power input to the LED lamp device can be reduced obviously. In particular, the greater electric power input to the LED lamp device, the more obvious effect produced by the resonance unit. Therefore, the resonance unit can perform the function of preventing the instant high voltage generated by the electronic ballast at the time of startup from damaging respective components in the driving unit 120 and the LED unit 110.

FIG. 4 illustrates a schematic view of an LED lamp device according to another embodiment of the present disclosure connected with an electronic ballast in an existing fluorescent lamp light-emitting circuit. For the sake of conciseness, the following descriptions will be made mainly on the difference of the present embodiment from the embodiment as shown in FIG. 2, and description of the components and operations identical to those shown in the embodiment as shown in FIG. 2 will be omitted.

As shown in FIG. 4, the resonance unit 130 of the LED lamp device 100 may include an inductor 131 and a capacitor 132, which are connected in series with each other. Based on the connection as shown in FIG. 4, when the resonance unit 130 receives the AC output of the electronic ballast 200, an oscillation will be formed in the series LC circuit composed of the inductor 131 and the capacitor 132.

When the electronic ballast 200 generates an instant high voltage during startup, the oscillation formed by the inductor 131 and the capacitor 132 of the resonance unit 130 can decrease the voltage provided to the driving unit 120 and the LED unit 110 behind the resonance unit 130 so as to protect respective components in the driving unit 120 and the LED unit 110 from being damaged by the output of the electronic ballast 200, such that the LED lamp device 100 can emit light by using the output of the electronic ballast 200.

In addition, during normal operations, the output power of the electronic ballast 200 is greater than the power needed for light emission by the LED unit 100. The series LC circuit composed of the inductor 131 and the capacitor 132 can flow a portion of the power which is not needed by the LED unit 110 back to the electronic ballast 200 in the form of reactive power, so that this portion of energy can be recovered by the electronic ballast 200, thereby improving the efficiency and saving energy sources.

Table 1 shows a measurement result of the total efficiency of a circuit composed of the LED lamp device of the present disclosure and one of different self-resonance electronic ballasts 1-4. In Table 1, Vᵢₙ, Iᵢₙ, and Pᵢₙ represent the voltage, current and power of an input end of the electronic ballast, respectively, PF represents the total power factor of the circuit, and V_{LED}, I_{LED} and P_{LED} represent the voltage across both ends of the LED unit and the current and power of the LED unit, respectively. As can be seen from Table 1, for all of the electronic ballasts, the total efficiency of the circuit is higher than 75% with different voltages input.

TABLE 1

| | Vᵢₙ(V) | Pᵢₙ(W) | Iᵢₙ(mA) | PF | V_{LED}(V) | I_{LED}(mA) | P_{LED}(W) | η(P_{LED}/Pᵢₙ) |
|---|---|---|---|---|---|---|---|---|
| self-resonance | 198 | 20.26 | 105.26 | 0.97 | 146 | 108.1 | 15.78 | 77.91% |
| electronic | 220 | 21.65 | 101.75 | 0.97 | 147.4 | 117.0 | 17.25 | 79.68% |
| ballast 1 | 240 | 22.64 | 98.26 | 0.96 | 148.3 | 122.3 | 18.14 | 80.11% |
| | 264 | 23.97 | 94.71 | 0.95 | 149.4 | 127.7 | 19.08 | 79.59% |
| self-resonance | 198 | 19.68 | 101.8 | 0.97 | 145.3 | 104.0 | 15.11 | 76.78% |
| electronic | 220 | 21.11 | 98.95 | 0.97 | 146.7 | 113.0 | 16.58 | 78.53% |
| ballast 2 | 240 | 22.17 | 96 | 0.96 | 147.8 | 119.3 | 17.64 | 79.55% |
| | 264 | 23.54 | 93.09 | 0.95 | 149.1 | 125.6 | 18.72 | 79.54% |
| self-resonance | 198 | 20.13 | 103.78 | 0.98 | 146.1 | 108.5 | 15.85 | 78.73% |
| electronic | 220 | 21.55 | 100.78 | 0.97 | 147.5 | 117.5 | 17.33 | 80.40% |
| ballast 3 | 240 | 22.68 | 97.93 | 0.96 | 148.6 | 123.5 | 18.35 | 80.90% |
| | 264 | 24.09 | 94.77 | 0.96 | 149.8 | 129.5 | 19.39 | 80.50% |
| self-resonance | 198 | 18.52 | 95.77 | 0.97 | 144.6 | 99.7 | 14.41 | 77.83% |
| electronic | 220 | 20.12 | 94.27 | 0.97 | 146.2 | 109.6 | 16.03 | 79.67% |
| ballast 4 | 240 | 21.38 | 92.14 | 0.96 | 147.4 | 117.2 | 17.27 | 80.77% |
| | 264 | 22.83 | 89.94 | 0.96 | 148.7 | 124.1 | 18.45 | 80.83% |

According to various embodiments, the inductance value of the inductor 131 and the capacitance value of the capacitor 132 of the resonance unit 130 may cause the resonance unit 130 as a whole to exhibit an inductive impedance when the output of the electronic ballast 200 is provided to the resonance unit 130. According to the electrical characteristic of the existing electronic ballast, it can supply power only to a load which exhibits a pure resistive impedance or an inductive impedance. If the load of the electronic ballast 200 exhibits a capacitive impedance, the electronic ballast 200 will turn off. Therefore, in replacing the conventional fluorescent lamp in the illumination circuit with the LED lamp device according to the present disclosure so as to upgrade the existing illumination circuit, the resonance unit 130 as a whole will exhibit an inductive impedance, so as to simplify operations, reduce cost, and enable the electronic ballast in the existing circuit to supply power normally.

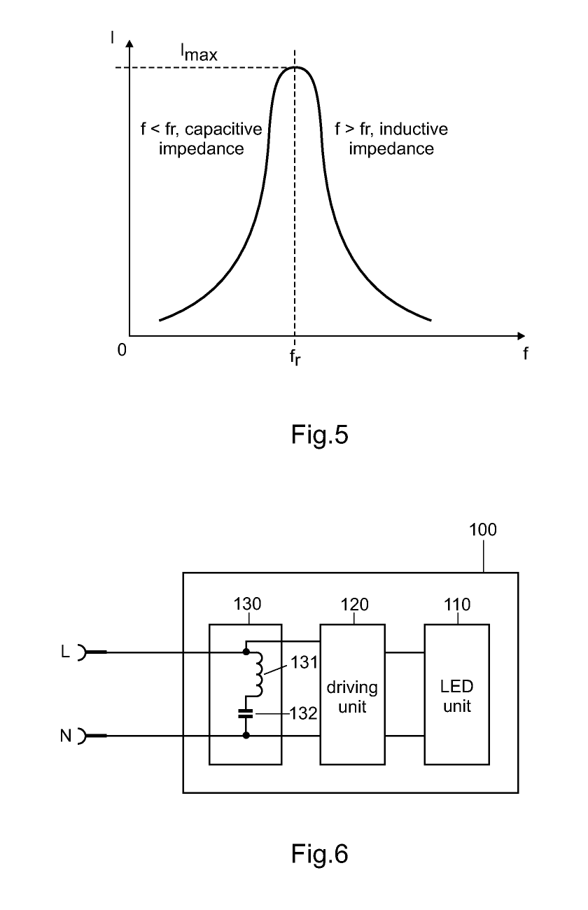

FIG. 5 schematically illustrates the relationship between the current and frequency in the circuit formed by connecting in series the inductor and capacitor in the resonance unit according to an embodiment of the present disclosure. In FIG. 5, the X-coordinate and Y-coordinate represent the frequency and the value of the current in the circuit formed by connecting in series the inductor and the capacitor, respectively. As shown in FIG. 5, a peak value Iₘₐₓ of the current I is present at a resonance point corresponding to the resonance frequency fᵣ of the LC circuit. When the frequency f of an AC voltage applied to the LC circuit (or an AC current flowing through the LC circuit) is greater than the resonance frequency fᵣ of the LC circuit, the LC circuit exhibits an inductive impedance. On the contrary, when the frequency f of an AC voltage applied to the LC circuit (or an AC current flowing through the LC circuit) is less than the resonance frequency fᵣ of the LC circuit, the LC circuit exhibits a capacitive impedance.

The inductive impedance X_{L} and capacitive impedance X_{C} of the circuit formed by connecting in series the inductor and the capacitor in the resonance unit are as shown in the following formulas (1) and (2):

$$\begin{matrix}{X}_{L} = 2 π fL & ( 1 ) \\ {X}_{C} = \frac{1}{2 π fC} & ( 2 )\end{matrix}$$

where L represents the inductance value of the inductor 131, and C represents the capacitance value of the capacitor 132.

Where X_{L}=X_{C}, that is,

$$2 π fL = \frac{1}{2 π fC} ,$$

the resonance frequency fᵣ of the LC circuit can be calculated as shown in the following formula (3):

$${f}_{r} = \frac{1}{2 π \sqrt{LC}} \qquad ( 3 )$$

Referring to FIG. 5, it would be appreciated that, for a given frequency f of an alternating voltage (or an alternating current), the less resonance frequency fᵣ of the LC circuit, the more probability that the LC circuit tends to exhibit an inductive impedance. In other words, in order to enable the resonance unit 130 as a whole to exhibit an inductive impedance upon the receipt of the output of the electronic ballast 200, the inductance value L of the inductor 131 and the capacitance vale C of the capacitor 132 in the resonance unit 130 shall cause the resonance frequency fᵣ of the LC circuit to be less than the frequency f_{ECG} of the output voltage of the electronic ballast 200, namely, L and C satisfy the following formula (4):

$$\frac{1}{2 π \sqrt{LC}} < {f}_{ECG} \qquad ( 4 )$$

Preferably, L and C satisfy the following formula (5):

$$\frac{1}{2 π \sqrt{LC}} < \frac{{f}_{ECG}}{2} \qquad ( 5 )$$

As can be seen from the above formulas, the larger values of L and C, the more probability that the resonance unit 130 as a whole tends to exhibit an inductive impedance when receiving the AC output of the electronic ballast 200. However, the physical sizes of the inductor 131 and the capacitor 132 will be increased with the increase of the values of L and C. In replacing the conventional fluorescent lamp in the illumination circuit with the LED lamp device according to the present disclosure so as to upgrade the existing illumination circuit, the size of the LED lamp device is required to be the same as or similar to that of the existing fluorescent lamp so as to facilitate operations. Those skilled in the art can select the suitable L and C according to the requirements in practice, so as to satisfy the formula (4) or (5) while meeting the requirements in terms of the size of the LED lamp device.

According to various embodiments, the frequency of the output voltage of the electronic ballast in the existing illumination circuit is about 25-70 kHz. Therefore, the inductance value L of the inductor 131 and the capacitance value C of the capacitor 132 of the resonance unit 130 cause the resonance frequency fᵣ of the LC circuit to be less than 25 kHz, preferably less than 20 kHz, and more preferably less than 12.5 kHz.

FIG. 6 illustrates a schematic view of an LED lamp device according to another example of the present disclosure connected to an AC voltage source. As shown in FIG. 6, in the absence of an electronic ballast, the resonance unit 130 of the LED lamp device 100 can be connected directly to the AC voltage source, wherein L represents a live line, and N represents a neutral line. According to the example, the inductance value of the inductor 131 and the capacitance value of capacitor 132 of the resonance unit 130 cause the resonance unit 130 as a whole to exhibit a capacitive impedance when the resonance unit 130 is connected to the AC voltage source.

For the applicability to the output of the electronic ballast 200 as described above, the LED lamp device 100 according to the present disclosure has a resonance unit 130. When the resonance unit 130 is arranged to be connected directly to the AC voltage source, the resonance unit 130 as a whole exhibits a capacitive impedance. Thus, after being connected directly to the AC voltage source, the resonance unit 130 may not influence the electric power provided by the AC voltage source, substantively, such that the output of the AC voltage source almost without being subjected to any conversion can act on the driving unit 120 and the LED unit 110 behind the resonance unit 130, for light emission.

In such a way, the LED lamp device 100 including the resonance unit 130 according to the present disclosure can also be connected directly to an AC voltage source such as civilian or industrial electricity (with a voltage of 220 V or 380 V) for illumination, without an electronic ballast in the existing circuit.

Referring to FIG. 5, it would be appreciated that, for a given AC voltage source, its frequency f is fixed. The larger resonance frequency fᵣ of the series circuit of the inductor 131 and the capacitor 131, the more probability that the LC circuit more tends to exhibit a capacitive impedance. In other words, in order to enable the resonance unit 130 as a whole to exhibit a capacitive impedance when being connected directly to an AC voltage source, the inductance value L of the inductor 131 and the capacitance vale C of the capacitor 132 in the resonance unit 130 shall cause the resonance frequency fᵣ of the LC circuit to be larger than the frequency f_{AC} of the output voltage of the AC voltage source, namely, L and C satisfy the following formula (6):

$$\frac{1}{2 π \sqrt{LC}} > {f}_{A C} \qquad ( 6 )$$

Preferably, L and C satisfy the following formula (7):

$$\frac{1}{2 π \sqrt{LC}} > 2 {f}_{A C} \qquad ( 7 )$$

According to various embodiments, the frequency of the output voltage of the AC voltage source such as civilian or industrial electricity is about 50-60 Hz. Therefore, the inductance value L of the inductor 131 and the capacitance vale C of the capacitor 132 of the resonance unit 130 cause the resonance frequency fᵣ of the LC circuit to be larger than 60 Hz, preferably larger than 100 Hz, and more preferably larger than 120 Hz.

As can be seen from the above formulas (4)-(7), the LED lamp device according to an embodiment of the present disclosure can emit light not only when being connected to an electronic ballast in the existing illumination circuit, but also when being connected directly to an AC voltage source in the absence of an electronic ballast. Thus, the inductance value L of the inductor 131 and the capacitance vale C of the capacitor 132 in the resonance unit 130 of the LED lamp device shall satisfy the following formula (8):

$${f}_{A C} < \frac{1}{2 π \sqrt{LC}} < {f}_{ECG} \qquad ( 8 )$$

Preferably, L and C satisfy the following formula (9):

$$2 {f}_{A C} < \frac{1}{2 π \sqrt{LC}} < \frac{{f}_{ECG}}{2} \qquad ( 9 )$$

Therefore, the LED lamp device according to the embodiment is adapted to emit light not only by using the output of the existing electronic ballast when replacing the conventional fluorescent lamp in the illumination circuit, but also by being connected directly to an AC voltage source in the absence of an electronic ballast in the existing circuit. That is, the LED lamp device according to the embodiment is compatible with both of the electronic ballast and the AC voltage source.

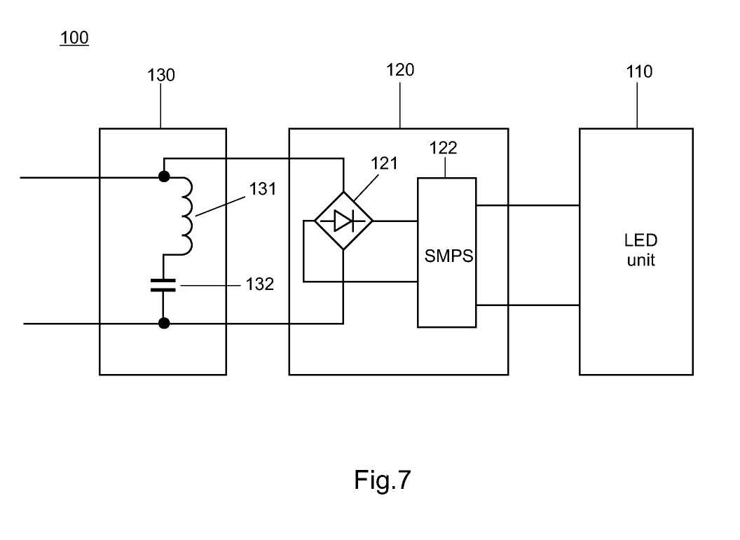

FIG. 7 illustrates a schematic view of an LED lamp device according to another embodiment of the present disclosure. As shown in FIG. 7, the driving unit 120 of the LED lamp device 100 includes a bridge rectifier 121 and a switch mode power supply (SMPS) 122. The bridge rectifier 121 is connected to the resonance unit 130, and converts the AC from the resonance unit 130 to DC, and the DC is provided to the LED unit 110 by the switch mode power supply 122. The switch mode power supply 122 is connected between the bridge rectifier 121 and the LED unit 110, for providing the DC converted by the bridge rectifier 121 to the LED unit 110 and adjusting DC power provided to the LED unit 110.

As would be appreciated by those skilled in the art, in the case that the input power of the LED lamp device and the load impedance to the switch mode power supply (i.e. an equivalent impedance of the LED unit) are in a positive change relationship (that is, the input power of the LED lamp device will increase with increase of the load impedance), the switch mode power supply needs to have a positive feedback control loop. On the contrary, in the case that the input power of the LED lamp device and the load impedance to the switch mode power supply are in a negative change relationship (that is, the input power of the LED lamp device will decrease with increase of the load impedance), the switch mode power supply needs to have a negative feedback control loop.

Referring again to FIG. 3, when the LED lamp device having the resonance unit according to the present disclosure is connected to a self-resonance electronic ballast, the input power of the LED lamp device (i.e. output power of the self-resonance electronic ballast) will decrease with increase of the equivalent impedance of the LED unit. According to an example of the present disclosure, the switch mode power supply 122 included in the LED lamp device 100 as shown in FIG. 7 has a negative feedback control loop. Therefore, the switch mode power supply 122 is suitable for the case where the input power of the LED lamp device and the load impedance are in a negative change relationship. That is, when the switch mode power supply 122 has a negative feedback control loop, the LED lamp device 100 can emit light by using the output of the self-resonance electronic ballast in the existing illumination circuit due to the resonance unit 130 included in the LED lamp device 100. As would be appreciated by those skilled in the art, the LED lamp device 100 including the switch mode power supply 122 having the negative feedback control loop is also adapted to emit light by using the output of an AC voltage source. Therefore, the LED lamp device according to the present example is adapted to emit light not only by using the output of the existing self-resonance electronic ballast when replacing the conventional fluorescent lamp in the illumination circuit, but also by being connected directly to an AC voltage source in the absence of an electronic ballast in the existing circuit. That is, the LED lamp device according to the present example is compatible with both of the self-resonance electronic ballast and the AC voltage source.

However, a non-self-resonance electronic ballast has an output characteristic different from that of the self-resonance electronic ballast. When the LED lamp device having the resonance unit according to the present disclosure is connected to a non-self-resonance electronic ballast, the input power of the LED lamp device (i.e. the output power of the non-self-resonance electronic ballast) will increase with increase of the equivalent impedance of the LED unit. According to another example of the present disclosure, the switch mode power supply 122 included in the LED lamp device 100 as shown in FIG. 7 has a positive feedback control loop. Therefore, the switch mode power supply 122 is suitable for the case where the input power of the LED lamp device and the load impedance are in a positive change relationship. That is, when the switch mode power supply 122 has a positive feedback control loop, the LED lamp 100 can emit light by using the output of the non-self-resonance electronic ballast in the existing illumination circuit.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

What is claimed is:

1. An LED lamp device, comprising:
an LED unit for emitting light;
a driving unit for driving the LED unit such that the LED unit emits light at an operating point; and
a resonance unit for receiving an input, providing AC power to the driving unit, and protecting the driving unit and the LED unit from being damaged by the input.

2. The LED lamp device according to claim 1, wherein the resonance unit comprises an inductor and a capacitor which are connected in series.

3. The LED lamp device according to claim 2, wherein an inductance value of the inductor and a capacitance value of the capacitor cause the resonance unit to exhibit an inductive impedance when the resonance unit receives an output of an electronic ballast as the input.

4. The LED lamp device according to claim 3, wherein the inductance value of the inductor and the capacitance value of the capacitor satisfy either of the following two formulae:
$$\frac{1}{2 π \sqrt{LC}} < {f}_{ECG}$$
$$and$$
$$\frac{1}{2 π \sqrt{LC}} < \frac{{f}_{ECG}}{2}$$
where L represents the inductance value of the inductor, C represents the capacitance value of the capacitor, and f_{ECG} represents a frequency of an output voltage of the electronic ballast.

5. The LED lamp device according to claim 3, wherein the frequency of the output voltage of the electronic ballast is 25-70 kHz.

6. The LED lamp device according to claim 2, wherein the inductance value of the inductor and the capacitance value of the capacitor satisfy either of the following two formulae:
$${f}_{A C} < \frac{1}{2 π \sqrt{LC}} < {f}_{ECG}$$
$$and$$
$$2 {f}_{A C} < \frac{1}{2 π \sqrt{LC}} < \frac{{f}_{ECG}}{2}$$
where L represents the inductance value of the inductor, C represents the capacitance value of the capacitor, f_{AC} represents a frequency of an output voltage of an AC voltage source when the resonance unit receives an output of the AC voltage source as the input, and f_{ECG} represents a frequency of an output voltage of an electronic ballast when the resonance unit receives an output of the electronic ballast as the input.

7. The LED lamp device according to claim 6, wherein the frequency of the output voltage of the electronic ballast is 25-70 kHz, and the frequency of the output voltage of the AC voltage source is 50-60 Hz.

8. The LED lamp device according to claim 1, wherein the driving unit comprises:
a bridge rectifier for converting an AC from the resonance unit to a DC; and
a switch mode power supply for providing the DC converted by the bridge rectifier to the LED unit, and adjusting power of the DC provided to the LED unit.

9. The LED lamp device according to claim 8, wherein the switch mode power supply is a switch mode power supply having a negative feedback control loop when the resonance unit receives an output of a self-resonance electronic ballast or an AC voltage source as the input.

10. The LED lamp device according to claim 8, wherein the switch mode power supply is a switch mode power supply having a positive feedback control loop when the resonance unit receives an output of a non-self-resonance electronic ballast as the input.

11. The LED lamp device according to claim 4, wherein the frequency of the output voltage of the electronic ballast is 25-70 kHz.
